(19) United States
(12) Patent Application Publication
(10) Pub. No.: US 2025/0389961 A1
(43) Pub. Date: Dec. 25, 2025

(54) LIGHT-TRANSMITTING DEVICE

(71) Applicant: AUO Corporation, Hsinchu City (TW)

(72) Inventors: Yu-Ting HU, Hisnchu City (TW); Hsin-Chang LIN, Hsinchu City (TW); Seok-Lyul LEE, Hsinchu City (TW); Sheng-Ming HUANG, Hsinchu City (TW); Ming-Jui WANG, Hsinchu City (TW); Chih-Chiang CHEN, Hsinchu City (TW); Chia-Hsin CHUNG, Hsinchu City (TW); Yen-Chun CHIANG, Hsinchu City (TW); Ting-Wei TSAI, Hsinchu City (TW); Li-Ying LIU, Hsinchu City (TW)

(21) Appl. No.: 18/972,093

(22) Filed: Dec. 6, 2024

(30) Foreign Application Priority Data
Jun. 19, 2024 (TW) 113122736
Nov. 8, 2024 (TW) 113143054

(51) Int. Cl. G02B 27/01

(52) U.S. Cl. CPC G02B 27/0172

(57) ABSTRACT

A light-transmitting device includes a waveguide and first, second, and third grating regions. The first grating region is located on a first or a second surface of waveguide and has a first grating structure. The first grating structure allows a light to enter the waveguide. The second grating region is located on the first surface and has a second grating structure. The second grating structure is receives the light from the first grating region and to redirect the light. The third grating region is located on the first surface and has a third grating structure. The third grating structure receives the light from the second grating region and allows the light to leave the waveguide. A height of the second grating structure and a height of the third grating structure are less than the one-tenth of a height of the first grating structure.

### CROSS-REFERENCE TO RELATED APPLICATIONS

This application claims priority to Taiwan Application Serial Number 113122736, filed Jun. 19, 2024, and Taiwan Application Serial Number 113143054, filed Nov. 8, 2024, which are herein incorporated by reference.

### BACKGROUND

### Field of Invention

The present disclosure relates a light-transmitting device.

### Description of Related Art

Augmented Reality (AR) is a technology that combines the real environment with images displaying virtual objects. With the development of various software and hardware, AR technology has made significant progress and has begun to be applied in a variety of electronic devices.

Among the various applications of AR, the technology of AR glasses is noteworthy. AR glasses typically use a light guide element formed by combining a waveguide plate with multiple sets of grating structures as lenses. Through the diffraction effect of the grating, the light emitted by a small projector equipped with the glasses is guided through the waveguide plate and projected into the user's eyes, such that the user can simultaneously view the surrounding real environment and the virtual images projected by the small projector.

### SUMMARY

According to an embodiment of the present disclosure, a light-transmitting device includes a waveguide plate, a first grating region, a second grating region, and a third grating region. The waveguide plate has opposing first and second surfaces. The first grating region is located on either the first surface or the second surface and has a first grating structure. The first grating structure is configured to allow light to enter the waveguide plate. The second grating region is located on the first surface and has a second grating structure. The second grating structure is configured to receive light from the first grating region and redirect the light. The third grating region is located on the first surface and has a third grating structure. The third grating structure is configured to receive light from the second grating region and emit the light out of the waveguide plate. The height of the second grating structure and the height of the third grating structure are both less than one-tenth of the height of the first grating structure.

In some embodiments, the height of the first grating structure is greater than 1 micrometer.

In some embodiments, the height of the second grating structure is in the range of 10 nm to 300 nm.

In some embodiments, the height of the third grating structure is in the range of 10 nm to 300 nm.

In some embodiments, the light-transmitting device further includes a buffer layer located between the first grating region and the waveguide plate.

In some embodiments, the light-transmitting device further includes a medium layer located between the buffer layer and the waveguide plate.

In some embodiments, the material of the medium layer is optical adhesive.

In some embodiments, the refractive index of the buffer layer is greater than or equal to the refractive index of the medium layer, and the refractive index of the medium layer is greater than or equal to the refractive index of the waveguide plate.

In some embodiments, the thickness of the buffer layer is in the range of 0.1 mm to 10 mm.

In some embodiments, the thickness of the buffer layer satisfies the equation: D≥(A^{0.5}−T×tan θ_{d})/tan θ_{d}, where D is the thickness of the buffer layer, A is the area of the first grating region, T is the thickness of the waveguide plate, and θ_{d} is the angle of diffraction of the light as it enters the waveguide plate through the first grating structure.

In some embodiments, the area of the third grating region is greater than or equal to the area of the second grating region.

In some embodiments, the area of the second grating region is greater than ten times the area of the first grating region.

In some embodiments, the second grating region has a plurality of sub-regions, and each sub-region has a different diffraction efficiency.

In some embodiments, the second grating structure in the same sub-region of the second grating region has the same height and width.

In some embodiments, the second grating structure in different sub-regions of the second grating region has different heights or different widths.

In some embodiments, plural boundary lines of the sub-regions of the second grating region form an angle with the horizontal direction, and this angle satisfies the equation: ϕ=tan⁻¹(β₁/α₁), where α₁=(−λ sin ψ+αd)/nd, β₁=(λ cos ψ+βd)/nd, α=sin θ×cos ψ, β=sin θ×sin ψ, ϕ is the angle, λ is the wavelength of the light, θ is an viewing angle, n is the refractive index of the waveguide plate, ψ is the direction of the grating vector of the first grating region, and d is the grating period distance of the first grating region.

In some embodiments, the number of sub-regions in the second grating region is at least three.

In some embodiments, the first grating structure is a bulk grating.

In some embodiments, the second grating structure is a nano-microstructure grating.

In some embodiments, the third grating structure is a nano-microstructure grating.

In the aforementioned light-transmitting device, since the height of the second grating structure and the height of the third grating structure are both less than one-tenth of the height of the first grating structure, the first grating structure can provide better light guiding energy efficiency when light enters the first grating structure. Additionally, the design of the second grating region allows for a more uniform energy distribution of the projected light. Therefore, when such a light-transmitting device is applied to the lenses of augmented reality (AR) glasses, it can provide images with higher and more uniform brightness.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a top view of a light-transmitting device according to an embodiment of the present disclosure.

FIG. 2A is a side view of the light-transmitting device in FIG. 1.

FIG. 2B is a schematic view when a first grating region in FIG. 1 receives an image of a light source.

FIG. 3A is a partially enlarged view of the second grating structure in FIG. 2A

FIG. 3B is a partially enlarged view of a second grating structure according to another embodiment of the present disclosure.

FIG. 3C is a partially enlarged top view of the first grating region in FIG. 1.

FIG. 4 is a partially enlarged view of a single sub-region in FIG. 3A or FIG. 3B.

FIG. 5A is a partially enlarged view of an area near the first grating region in FIG. 2A.

FIG. 5B is a partially enlarged view of an area near a first grating region of a light-transmitting device according to another embodiment of the present disclosure.

FIG. 6 is a side view of a light-transmitting device according to yet another embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Spatial relative terms such as “under,” “below,” “bottom,” “on,” “top,” etc., may be used herein for convenience of description to describe the relationship of one element or feature to another element or feature as illustrated in the figures. The spatial relative terms are intended to encompass different orientations of the device in use or operation other than the orientation depicted in the figures. The device may be otherwise oriented (rotated 90 degrees or in other orientations), and the spatial relative descriptors used herein may be interpreted accordingly.

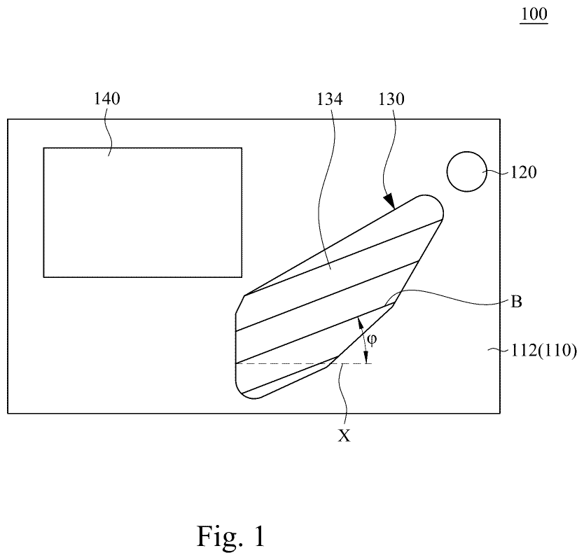

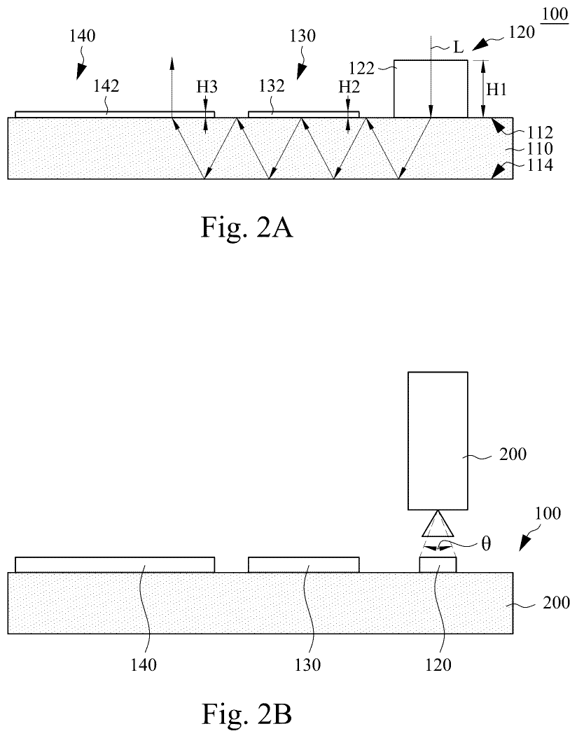

FIG. 1 is a top view of a light-transmitting device 100 according to an embodiment of the present disclosure. FIG. 2A is a side view of the light-transmitting device 100 in FIG. 1. Referring to FIG. 1 and FIG. 2A, the light-transmitting device 100 includes a waveguide plate 110, a first grating region 120, a second grating region 130, and a third grating region 140. The waveguide plate 110 has a first surface 112 and a second surface 114 opposite to each other. The first grating region 120 is located on the first surface 112 and has a first grating structure 122. The first grating structure 122 is configured to allow light L to enter the waveguide plate 110. The second grating region 130 is located on the first surface 112 and has a second grating structure 132. The second grating structure 132 is configured to receive the light L from the first grating region 120 and redirect the light L. The third grating region 140 is located on the first surface 112 and has a third grating structure 142. The third grating structure 142 is configured to receive the light L from the second grating region 130 and emit the light L out of the waveguide plate 110 for viewing by the human eye.

In this embodiment, the second grating region 130 is illustrated with five sub-regions 134, but is not limited thereto. The area of the third grating region 140 is greater than or equal to the area of the second grating region 130, and the area of the second grating region 130 is greater than ten times the area of the first grating region 120. The height H2 of the second grating structure 132 and the height H3 of the third grating structure 142 are both less than one-tenth of the height H1 of the first grating structure 122. In this embodiment, the height H2 of the second grating structure 132 and the height H3 of the third grating structure 142 are both in the range of 10 nm to 300 nm. In other embodiments, the height H2 of the second grating structure 132 and the height H3 of the third grating structure 142 are at a nanoscale, while the height H1 of the first grating structure 122 is at a microscale. For example, the height H1 of the first grating structure 122 may be 2000 nm, the height H2 of the second grating structure 132 may be 10 nm to 150 nm, and the height H3 of the third grating structure 142 may be 60 nm.

Specifically, since the height H2 of the second grating structure 132 and the height H3 of the third grating structure 142 are both less than one-tenth of the height H1 of the first grating structure 122, the first grating structure 122 can provide better light guiding energy efficiency when light L enters the first grating structure 122.

FIG. 2B is a schematic view when the first grating region 120 in FIG. 1 receives an image of a light source 200. The light-transmitting device 100 receives image light from the light source 200 by the first grating region 120. FIG. 2B is merely for expressing the concept of an viewing angle θ in the following description. In fact, the heights of the grating structures of the first grating region 120, the second grating region 130, and the third grating region 140 are as mentioned above.

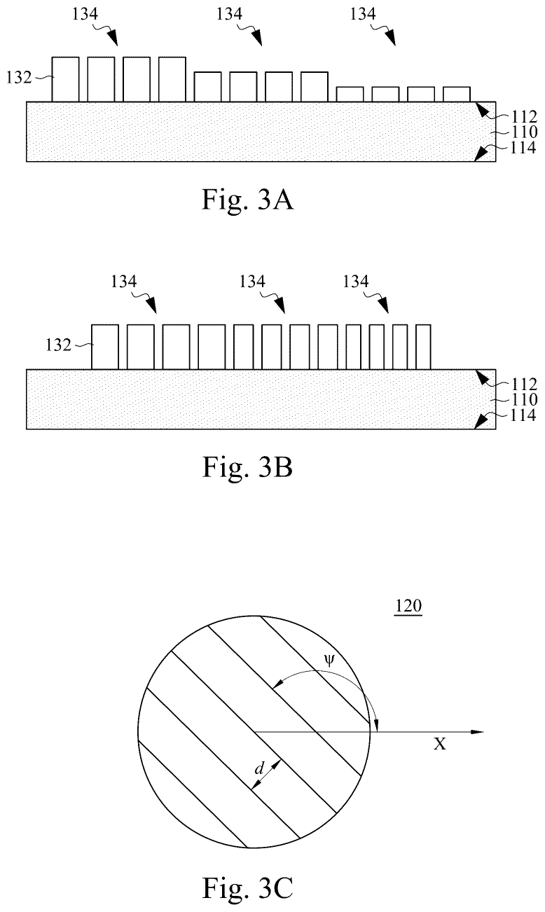

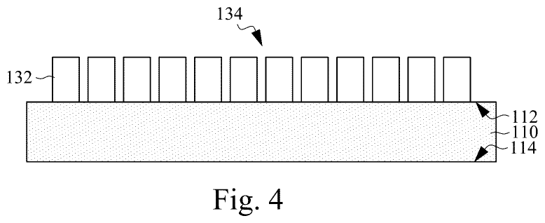

FIG. 3A is a partially enlarged view of the second grating structure 132 in FIG. 2A. FIG. 3B is a partially enlarged view of the second grating structure 132 according to another embodiment of the present disclosure. Referring to FIG. 2A and FIG. 3A, in this embodiment, the second grating region 130 has plural sub-regions 134, and the height of the second grating structure 132 in different sub-regions 134 varies. Referring to FIG. 2A and FIG. 3B, in this embodiment, the width of the second grating structure 132 in different sub-regions 134 of the second grating region 130 varies. Referring to FIG. 4, the height of the second grating structure 132 in the same sub-region 134 is the same, and the width of the second grating structure 132 in the same sub-region 134 is the same. In this way, the second grating structure 132 in different sub-regions 134 can have different diffraction efficiencies. The design of the sub-regions 134 in the second grating region 130 allows for a more uniform energy distribution of the projected light L (illustrated in FIG. 2A). Therefore, when such a light-transmitting device 100 is applied to the lenses of augmented reality (AR) glasses, it can provide images with higher and more uniform brightness. Additionally, in some embodiments, the height of the second grating structure 132 in the same sub-region 134 of the second grating region 130 is the same, as shown in FIG. 4.

Referring to FIG. 3A and FIG. 3B, FIG. 3A and FIG. 3B illustrate a partial enlargement of three sub-regions 134. However, in other embodiments, the number of sub-regions 134 may be different. In some embodiments, the number of sub-regions 134 is at least three. The boundary line B of the sub-regions 134 forms an angle ϕ (see FIG. 1) with a horizontal direction X, and the angle ϕ satisfies the equation: ϕ=tan⁻¹(β₁/α₁), where α₁=(−λ sin ψ+αd)/nd, β₁=(λ cos ψ+βd)/nd, α=sin θ×cos ψ, β=sin θ×sin ψ, λ is the wavelength of the light L, θ is the viewing angle (see FIG. 2B), n is the refractive index of the waveguide plate 110. The direction of the grating vector ψ (see FIG. 3C) described here is an angle between the extending direction of the gap of the first grating region 120 and a horizontal direction X that is the same as or parallel to the horizontal direction X of the aforementioned angle ϕ, and d is the grating period distance of the first grating region 120. In this way, the energy distribution of the light L from the second grating region 130 to the third grating region 140 can be more uniform, thereby allowing the light-transmitting device 100 to provide a more uniform brightness distribution in the projected image.

In this embodiment, the first grating structure 122 is a bulk grating. As a result, the design of the bulk grating can enable the first grating structure 122 to have a higher height H1, for example, reaching more than 1 micrometer. In this embodiment, the second grating structure 132 is a nano-microstructure grating, which can be formed by imprinting. Additionally, the third grating structure 142 is a nano-microstructure grating similar to the nano-microstructure grating of the second grating structure 132. In this way, the optical properties of the second grating structure 132 and the third grating structure 142 can be finely controlled, which allows the second grating region 130 to form plural sub-regions 134 with different diffraction efficiencies.

By combining the use of the bulk grating for the first grating structure 122 and the nano-microstructure gratings for the second grating structure 132 and the third grating structure 142, the grating coupling efficiency of the light-transmitting device 100 can be improved. Compared to a light-transmitting device using only nano-microstructure gratings, the grating coupling efficiency of the light-transmitting device 100 in this embodiment can be improved by approximately 57%. Therefore, when the light-transmitting device 100 is applied to the lenses of augmented reality (AR) glasses, it can provide images with higher and more uniform brightness.

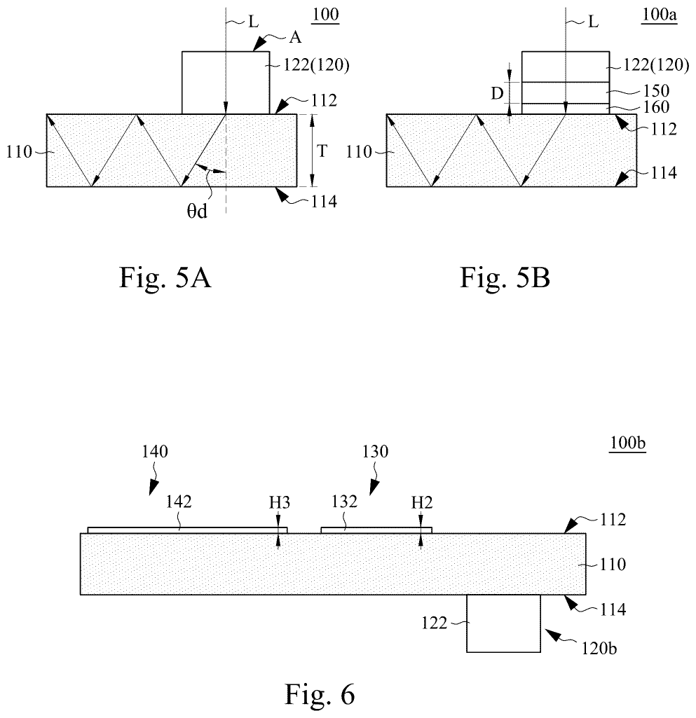

FIG. 5A is a partially enlarged view of an area near the first grating region 120 in FIG. 2A. FIG. 5B is a partially enlarged view of an area near the first grating region 120 of a light-transmitting device 100a according to another embodiment of the present disclosure. Referring to both FIG. 5A and FIG. 5B, the difference between the light-transmitting device 100a and the light-transmitting device 100 is that the light-transmitting device 100a further includes a buffer layer 150 and a medium layer 160. The buffer layer 150 of the light-transmitting device 100a is located between the first grating region 120 and the waveguide plate 110, and the medium layer 160 is located between the buffer layer 150 and the waveguide plate 110. The refractive index of the buffer layer 150 of the light-transmitting device 100a is greater than or equal to the refractive index of the medium layer 160, and the refractive index of the medium layer 160 is greater than or equal to the refractive index of the waveguide plate 110. In some embodiments, the material of the medium layer 160 can be optical adhesive to fix the buffer layer 150 onto the waveguide plate 110. The buffer layer 150 of the light-transmitting device 100a can reduce the secondary coupling effect that easily occurs in the first grating region 120, thereby reducing the loss of energy efficiency.

In some embodiments, a thickness D of the buffer layer 150 may be in the range of 0.1 mm to 10 mm, for example, 7 mm, and the thickness D of the buffer layer 150 satisfies the equation: D≥(A^{0.5}−T×tan θ_{d})/tan θ_{d}, where D is the thickness of the buffer layer 150, A is the area of the first grating region 120, T is the thickness of the waveguide plate 110, and θ_{d} is the diffraction angle of the light L as it enters the waveguide plate 110 through the first grating structure 122. Such a thickness D can provide optimal coupling efficiency.

FIG. 6 is a side view of a light-transmitting device 100b according to yet another embodiment of the present disclosure. As shown in FIG. 6, the light-transmitting device 100b includes the waveguide plate 110, a first grating region 120b, the second grating region 130, and the third grating region 140. The difference between the light-transmitting device 100b and the light-transmitting device 100 in FIG. 2A is that the first grating region 120b of the light-transmitting device 100b is located on the second surface 114 of the waveguide plate 110, and there is no first grating region 120b on the first surface 112 of the waveguide plate 110 of the light-transmitting device 100b. This light-transmitting device 100b has the same advantages as the aforementioned light-transmitting device 100. Therefore, based on the design of augmented reality (AR) glasses, disposing the first grating region 120 on the first surface 112 of the waveguide plate 110 or disposing the first grating region 120b on the second surface 114 of the waveguide plate 110 may be selected.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A light-transmitting device, comprising:
a waveguide plate having a first surface and a second surface opposite to each other;
a first grating region located on the first surface or the second surface, the first grating region having a first grating structure configured to allow a light to enter the waveguide plate;
a second grating region located on the first surface, the second grating region having a second grating structure configured to receive the light from the first grating region and redirect the light; and
a third grating region located on the first surface, the third grating region having a third grating structure configured to receive the light from the second grating region and emit the light out of the waveguide plate, wherein a height of the second grating structure and a height of the third grating structure are both less than one-tenth of a height of the first grating structure.

2. The light-transmitting device of claim 1, wherein the height of the first grating structure is greater than 1 micrometer.

3. The light-transmitting device of claim 1, wherein the height of the second grating structure is in a range of 10 nm to 300 nm.

4. The light-transmitting device of claim 1, wherein the height of the third grating structure is in a range of 10 nm to 300 nm.

5. The light-transmitting device of claim 1, further comprising:
a buffer layer located between the first grating region and the waveguide plate.

6. The light-transmitting device of claim 5, further comprising:
a medium layer located between the buffer layer and the waveguide plate.

7. The light-transmitting device of claim 6, wherein a material of the medium layer is optical adhesive.

8. The light-transmitting device of claim 6, wherein a refractive index of the buffer layer is greater than or equal to a refractive index of the medium layer, and the refractive index of the medium layer is greater than or equal to the refractive index of the waveguide plate.

9. The light-transmitting device of claim 5, wherein a thickness of the buffer layer is in a range of 0.1 mm to 10 mm.

10. The light-transmitting device of claim 9, wherein the thickness of the buffer layer satisfies:
D≥(A^{0.5}−T×tan θ_{d})/tan θ_{d},
where D is the thickness of the buffer layer, A is an area of the first grating region, T is a thickness of the waveguide plate, and θ_{d} is a diffraction angle of the light as the light enters the waveguide plate through the first grating structure.

11. The light-transmitting device of claim 1, wherein an area of the third grating region is greater than or equal to an area of the second grating region.

12. The light-transmitting device of claim 11, wherein the area of the second grating region is greater than ten times an area of the first grating region.

13. The light-transmitting device of claim 1, wherein the second grating region has a plurality of sub-regions having different diffraction efficiencies than each other.

14. The light-transmitting device of claim 13, wherein the second grating structure in a same one of the sub-regions of the second grating region has the same height and the same width.

15. The light-transmitting device of claim 13, wherein the second grating structure in different ones of the sub-regions of the second grating region has different heights or different widths.

16. The light-transmitting device of claim 13, wherein a plurality of boundary lines of the sub-regions of the second grating region form an angle with a horizontal direction, and the angle satisfies:
ϕ=tan⁻¹(β₁/α₁),
where α₁=(−λ sin ψ+αd)/nd, β₁=(λ cos ψ+βd)/nd, α=sin θ×cos ψ, β=sin θ×sin ψ, ϕ is the angle, λ is a wavelength of the light, θ is a viewing angle, n is a refractive index of the waveguide plate, ψ is a direction of a grating vector of the first grating region, and d is a grating period distance of the first grating region.

17. The light-transmitting device of claim 13, wherein a number of the sub-regions in the second grating region is at least three.

18. The light-transmitting device of claim 1, wherein the first grating structure is a bulk grating.

19. The light-transmitting device of claim 1, wherein the second grating structure is a nano-microstructure grating.

20. The light-transmitting device of claim 1, wherein the third grating structure is a nano-microstructure grating.
